(19) United States
(12) Patent Application Publication
(10) Pub. No.: US 2023/0186707 A1
(43) Pub. Date: Jun. 15, 2023

(54) ASSET ENCLOSURE LOCK SYSTEM WITH ENCRYPTED IDENTIFICATION AND CREDENTIAL FUNCTIONALITY

(71) Applicant: Thomas James West, Blue Springs, MO (US)

(72) Inventor: Thomas James West, Blue Springs, MO (US)

(21) Appl. No.: 17/643,473

(22) Filed: Dec. 9, 2021

(51) Int. Cl. G07C 9/27; G07C 9/22; G07C 9/29; G07C 9/00

(52) U.S. Cl. CPC G07C 9/27; G07C 9/22; G07C 9/29; G07C 9/00309; E05B 47/0012

(57) ABSTRACT

An asset enclosure lock system includes a systemic lock device and a systemic unlock device. The lock device has a mechanical lock portion movable between an unlocked condition and a locked condition, locking an asset enclosure by way of physical engagement of the unlock device. Each device has an encrypted unique identifier that must match for the mechanical lock portion to move to the unlocked condition. The lock device is powered only by the unlock device or in other words dependently powered. The unique identifiers can be tracked as a function of time to create timestamps and an audit trail of successful engagements of a lock device and an unlock device as well as define limited time slots where specific unlock devices with successfully engage specific lock devices.

### BACKGROUND OF THE INVENTION

The present invention relates to lock box security and more particularly, to an asset enclosure lock system with encrypted identification and credential functionality.

Currently almost all traffic enclosures/cabinets in the United States use a publicly available #1 or #2 mechanical key. This is a decades old system that provides no security for such valuable assets. Furthermore, these assets are secured in unmonitored enclosures because the current system does not enable creation of an audit trail of who accessed the enclosure and when access to the enclosure was obtained. Moreover, these #1 and #2 mechanical keys are easily duplicated or purchased on Ebay™ and other online marketplaces, posing unnecessary risks to high value assets (and targets in the eyes of terrorists and anarchists) that play an important role in critical public safety systems (e.g., traffic, emergency response, power distribution, etc.).

Accordingly, there is a need for an asset enclosure lock system with encrypted identification and credential functionality. The system embodied in the present provides complete accountability for each person or department and for each operatively associated lock. Access to each lock can be monitored through a systemic unique identification number. Timestamps can monitor and control access as a function of time, such as limiting access to specified time slots. Every user and every lock have an encrypted element with no passwords and no wiring of the lock needed, thereby the present invention eliminates the use of mechanical keys and a need of an intrinsic power source in the lock body.

The system provides an exact replacement lock that encrypts the user identification and lock identification, providing a full encrypted audit trail, and timestamp of entry and closure. The present invention meets NIST security requirements for unmonitored equipment along with CALEA requirements for enclosures/cabinets that contain police/fire and federal circuits.

### SUMMARY OF THE INVENTION

In one aspect of the present invention, an asset enclosure lock system, the system including the following: a lock device having a mechanical lock movable between an unlocked condition and a locked condition capable of securing a structure; a lock computing device configured prevent the unlocked condition base on a match; and a lock radio-frequency identification (RFID) component having a lock identifier, the lock computing device operatively associated with the lock RFID component; an unlock device having: a key portion dimensioned to mechanically engage the mechanical lock for moving it between the unlocked and locked conditions; a unlock RFID component having a unlock identifier; and an unlock power source; and a software application configured to selectively define the match as a function of the lock and unlock identifier, and wherein the lock device is dependently powered by the unlock power source.

In another aspect of the present invention, an asset enclosure lock system, the software application defines a timestamp when the mechanical lock moves to the unlocked condition, wherein the unlock identifier is provided as indicia on the unlock device, wherein the unlock device provides two-way authentication through random numbers, wherein the key portion provides the unlock RFID component, wherein the mechanical lock provides the lock RFID component, and wherein the mechanical lock provides an anti-jam linkage.

These and other features, aspects and advantages of the present invention will become better understood with reference to the following drawings, description and claims.

### BRIEF DESCRIPTION OF THE DRAWINGS

FIG. 1 is a diagrammatic perspective view of an exemplary embodiment of the present invention, shown in use.

FIG. 2 is a front view of an exemplary embodiment of a systemic unlocking device of the present invention.

FIG. 3 is a perspective view of an exemplary embodiment of a systemic unlocking device of the present invention.

FIG. 4 is a perspective view of an exemplary embodiment of a systemic unlocking device of the present invention.

FIG. 5 is a perspective view of an exemplary embodiment of a systemic locking device of the present invention.

FIG. 6 is a perspective view of an exemplary embodiment of a systemic latch of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

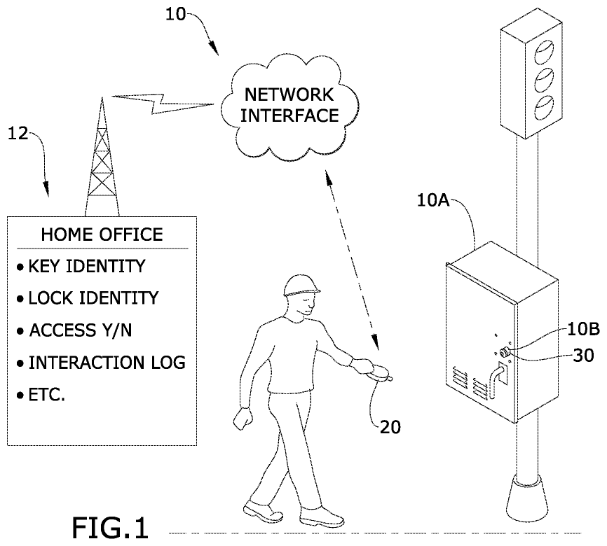

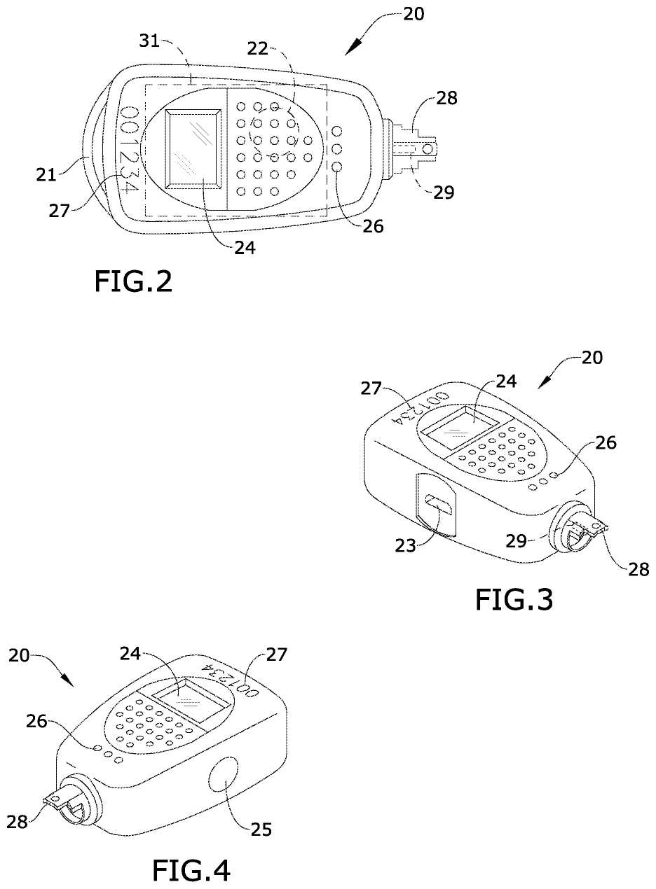

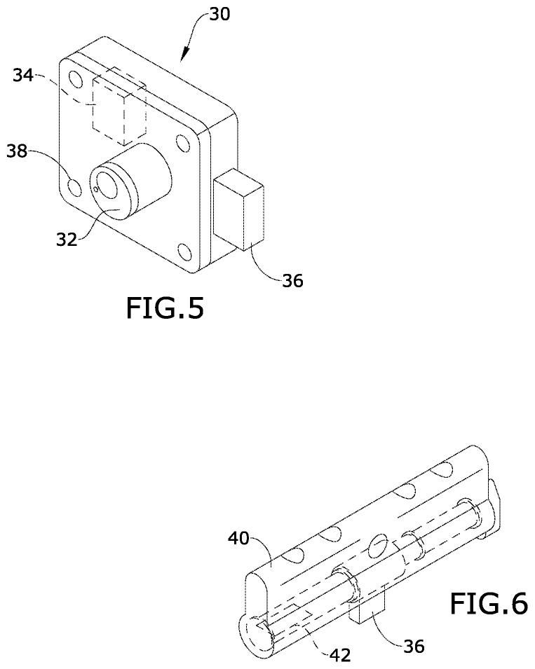

Referring to FIGS. 1 through 6, the present invention may include an asset enclosure lock system 10 having a locking device 30 and an unlocking device 20.

The locking device 30 has a mechanical lock portion 36 and a radio-frequency identification (RFID) component 34. The locking device 30 has a body portion 31 connected to the mechanical lock portion 36 and a lock barrel 32, wherein the mechanical lock portion 36 and the lock barrel 32 are mechanically associated to move the mechanical lock portion 36 between a locked condition and an unlocked condition. The mechanical lock portion 36 may be a square latch which is dimensioned to operatively associate with a pre-existing asset enclosure 10a. The lock barrel 32 is dimensioned and adapted for engaging a key portion 28 of the unlocking device 20 for mechanically moving between the locked condition and the unlocked condition.

The body portion 31 also houses the RFID component 34. The RFID component 34 may include a unique lock identifier and radio transponder, a radio receiver and transmitter, wherein the RFID component 34 is triggered by an interrogation pulse from a nearby RFID reader device (of the unlocking device 20) to transmit digital data identifying the unique lock identifier back to the reader. The unique lock identifier can be used to track and audit the occurrences of the locked condition and an unlocked condition and/or the transition between the different states (locked/unlocked conditions). The RFID component 34 may have both reader and transmitter functionality.

The unlocking device 20 may also have a RFID component as disclosed above that is operatively associated with an unlocking control circuitry associated with the unlocking device 20. This RFID component includes a unique unlock identified. The unlocking device 20 may be embodied in a key fob having the key portion 28 that physically engages the lock barrel 32 of the locking device 30 as disclosed above. The unlocking device 20 may have a housing providing lighting emitting devices 26 and a display 24. The unlocking device 20 may have a power source 22, such as a battery.

The unlocking device 20 may have a device ID 27, a charging port 23, a Bluetooth™ Light Energy (BLE) button 25, an encryption chip 29, and a hook 21 from which to hand the unlocking device 20.

Importantly, the locking device 30 may have a locking control circuitry with a transponder and signal-emitting circuits. The locking control circuitry has no battery or intrinsic power source; rather it is energized by the radio signals sent by the powered unlocking device 20. The locking control circuitry may have a computer chip that is programmed to respond by sending a coded signal back to the locking device 30. If the circuit does not respond or if the code is incorrect, the control circuitry of the locking device 30/RFID component 34 will not transmit the unique lock identifier and preventing moving the mechanical lock portion to the unlocked condition, thereby preventing theft from the asset enclosure 10a as well as tracking and auditing successful (i.e., matching coded signals from the unlocking device 20) credentialing. The locking control circuity may have timers by which to timestamp successful and unsuccessful (unresponsive and responsive) coded signaling between the locking device 30 and the unlocking device 20. The timer can also be used to limit successful code signaling as a function of time—i.e., creating times slots when certain unlock identifiers will and will not work with a specific locking device 30.

The communication between the locking control circuitry and the unlocking control circuitry may be enabled through short-range wireless technology capable of exchanging data between computing devices, such as Bluetooth™ and the like. A specific programming application interface (API,) a “I/O device” device capable of providing an interface between a processor and an external device capable of inputting and/or outputting binary data or other communication interface may be utilized to enable these wireless/RFID communication sessions. The communication interface may enable hashing for handshakes matching what is sent over the communication session, wherein the computing devices or control circuitry of the unlocking and the locking devices initiates a handshaking process therebetween During this handshake process, the locking/unlocking devices agree on various parameters used to establish security of the connection and generating hash values based on all the protocol messages sent between the two devices during the handshake.

The present invention may include a key database enabling parameters for adding keys, managing locks, and pairing hardware are set. Every key (unlocking device 20) is identified by the enciphered unique ID or unlock indentifier by way of its RFID component as disclosed above. Every lock is identified by an enciphered unique ID by its RFID component 34 lock identifier.

In certain embodiments, systemic software (possibly the encryption software 12) enables adding unlock devices 20, users, and managers when distributing the following types of keys: manager keys, individual keys, contractor keys, department keys, non-aging keys, periodic keys and timeliness keys; or delete other owners of a specified key. The systemic software may manage lock devices 30, subsidiary information is managed, including names, locations, GPS information and access type identifier.

Referring to FIG. 6, the mechanical lock portion 36 may be coupled to a housing 40 enclosing an encryption chip 42. The housing 40 may be stainless steel and sealed to be waterproof and have anti-corrosion properties, as well as high voltage and EMP isolator and ground. The encryption chip 42 may be built-in with a unique ID to prevent record unlocking. The encryption chip 42 may have 246-bit AES hashtag generator with linkage encryption, including micro logic for handshake and data authentication. The mechanical lock portion 36 may have components to prevent technical lock picking and violent lock removal. The mechanical lock portion 36 may have anti-jam linkage (hardened).

The present invention contemplates a network interface and an associated encryption software 12 configured to record and timestamp each active occurrence (moving between the locked and unlocked condition), whereby the present invention effectively enhances anti-theft, manages key databases, provides a complete audit trail and prevents password and data information from leaking. The encryption software 12 is needed to provide adequate hashing of the information disclosed above.

A method of using the present invention may include the following. The asset enclosure lock system 10 disclosed above may be provided. The locking device 30 may be installed in a pre-existing asset enclosure 10a through replacing the pre-existing lock box 10b with the unlocking device 30. The mechanical locking device 30 is an exact physical size of the replaced existing lock box 10b in terms of created locked and unlocked conditions with aid assent enclosure 10b. This exchange may include removing fasteners of the existing lock box 10b and using these fasteners (or equivalents) through mounting holes 38 of the locking device 30. No wiring is required, and no drilling or machining of the door is required. Access in now both granular and auditable.

The system embodied in the present invention can be used with a variety of lock bodies to secure other devices or items. It could also be used to activate access to electronics and systems due to its individualized nature, as well as be utilized to secure all types of infrastructure such as an “encrypted” padlocks, manhole covers, gas pipelines, gasoline facilities, area entry points, oil pipelines, water facilities and infrastructure, waste treatment facilities and infrastructure, construction equipment, construction sites, telecommunications facilities, and infrastructure as well as buildings.

In certain embodiments, the hardware and software are interlocked together. Each component is dependent upon the other. Designed for large institution requiring a complete audit trail, the four components (the mechanical lock, the lock RFID component, the unlock device, and the unlock RFID component) act as one in a contiguous link each providing failsafe checks on incoming and outgoing data (hashed). No link can be bypassed or tampered with. No data transfer in the clear. Data is encrypted and checked for authenticity before being passed to the next link—either up or down the four-component linkage. Designed for data integrity whether you are using traffic enclosure locks or padlocks. Specifically designed to meet full audit trail requirements of municipal/county/state or national government. Also designed to meet military, power utility, water utility, pharmaceutical and secure location requirements.

As a result, the present invention has the following advantages: works worldwide via the internet/only with the encrypted application; data cannot be tampered with; keys cannot be duplicated; and locks cannot be picked/jammed open or electrically interfered with. The present invention embodies miniaturized Bluetooth lock that cannot be physically jammed open (anti-jam mechanism), a miniaturized Bluetooth lock cannot be electrically opened (ESD protection/Grounded), a miniaturized Bluetooth lock cannot be physically jammed open (anti-jam mechanism), a miniaturized Bluetooth lock used 304 hardened stainless steel and gold contacts, and a miniaturized Bluetooth lock that is waterproof and has proprietary encryption chip and algorithms.

As a result, exact replacement for all traffic enclosure locks—no cabinet modifications required. The present invention works in all weather—no damage if exposed to flooding. A full audit trail of all authorized opening and closing events. Also, the present invention tracks all unauthorized lock attempts. The present invention is easy to read LED screen to indicate status as well as the following functionality: audible tone to indicate status, LED lights to indicate status, Rechargeable lithium battery, built-in hardware and algorithm for cross checking and authorization of data transfer (prevents man in middle attacks), and one button data exchange between mobile phone application and key.

The failsafe data chain of custody encrypted components are as follows:
a. Bluetooth Encrypted Bluetooth Lock Mechanism
b. Each mechanism is made of hardened 304 stainless steels
   i. Durability
   ii. Corrosion proof
b. Sealed and Waterproof/Dustproof
c. Unique 32 bit globally unique id
d. Anticorrosion coating and fully sealed
e. No wires/No batteries/No Maintenance
f. 256-bit AES Hashtag generator with Linkage Encryption
g. High Voltage and EMP Isolator with waterproof seals and ground
h. Micrologic for handshake and data authentication
i. Gold pins in lock for power/data and authentication exchange
j. Built in storage to prevent record unlocking
k. Hardened Anti-jam mechanism to prevent forcible unlocking/Violent lock removal
l. Pickproof lock/pickproof technical lock picking
m. Outdoor or indoor use certified
n. −40˜+85 C Hardened Temperature Range
o. Built in encryption chip/32-bit AES encryption
p. Bluetooth lock only works with authenticated and authorized Bluetooth key
q. There is no air exchange of data only from Bluetooth Key to gold pins
r. Logic authenticates key and lock via encrypted information
s. Record kept of lock id (unique id)/date and time stamp Key used
t. Records all unauthorized attempts to unlock
u. Full and complete audit tail of each transaction.
v. Miniaturized for multiple lock formats/replaces #1 and #2 Public keys
i. Traffic Enclosure Locks
ii. School Flasher Locks
iii. Universal Power Supply Cabinets (UPS)
iv. Padlocks
v. Transportation Industry seals

The unlocking device may be a Bluetooth™ encrypted key of 304 hardened stainless steel, audible beeps, LED readout and LED lights for status, wherein the key fob is rechargeable, has waterproof electronics, and a unique 32-bit global encrypted id for key. Links to Bluetooth Android Phone Application and verifies commands and data. Links to Locks—does handshake at point of contact. Downloads authorizations and uploads data from lock cylinder.

Additional features include:
Lightweight & Rechargeable—Mini USB C Connection—Data & Power
Power is in the Key—Lithium Battery
Waterproof—IP65
Encryption—AES 256-bit/on-board chip
Encrypted Handshake & Data—YES
Between Key and Lock
Between Key & Mobile Application
Temperature Range—−40˜+85 Degrees C
Accessible Keys—>2 Million
Encrypted Audit Trail—60,000 Audit Events & >20,000 Cylinders
Material—Stainless Steel
Key Compatibility—BLE 4.0
Certifications—NIST/CE/BLE/NEMA TS-2
Automated Database—Secured cloud by ORACLE

In certain embodiments, the network may refer to any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

In some embodiments, the computing systems may execute any suitable operating system such as IBM's zSeries/Operating System (z/OS), MS-DOS, PC-DOS, MAC-OS, WINDOWS, UNIX, OpenVMS, an operating system based on LINUX, or any other appropriate operating system, including future operating systems. In some embodiments, the computing systems may be a web server running web server applications such as Apache, Microsoft's Internet Information Server™, and the like.

In particular embodiments, the computing systems includes a processor, a memory, a user interface and a communication interface. In particular embodiments, the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface includes hardware, software, or both providing one or more interfaces for communication between a person and the computer systems. As an example and not by way of limitation, an user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface and any suitable user interfaces for them.

The communication interface includes hardware, software, or both providing one or more interfaces for communication (e.g., packet-based communication) between the computing systems over the network. As an example and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

It should be understood, of course, that the foregoing relates to exemplary embodiments of the invention and that modifications may be made without departing from the spirit and scope of the invention as set forth in the following claims.

What is claimed is:

1. An asset enclosure lock system, the system comprising:
a lock device comprising:
a mechanical lock movable between an unlocked condition and a locked condition capable of securing a structure;
a lock computing device configured prevent the unlocked condition base on a match; and
a lock radio-frequency identification (RFID) component having a lock identifier, the lock computing device operatively associated with the lock RFID component;
an unlock device comprising:
a key portion dimensioned to mechanically engage the mechanical lock for moving it between the unlocked and locked conditions;
a unlock RFID component is associated with a unlock identifier; and
an unlock power source; and
a software application configured to selectively define the match as a function of the lock and unlock identifier, and
wherein the lock device is dependently powered by the unlock power source.

2. The system of claim 1, wherein the match is defined as a function of time.

3. The system of claim 1, wherein the software application defines a timestamp when the mechanical lock moves to the unlocked condition.

4. The system of claim 1, wherein the unlock identifier is provided as indicia on the unlock device.

5. The system of claim 1, wherein the unlock device provides two-way authentication through random numbers.

6. The system of claim 1, wherein the key portion provides the unlock RFID component.

7. The system of claim 6, wherein the mechanical lock provides the lock RFID component.

8. The system of claim 7, wherein the mechanical lock provides an anti-jam linkage.
